(19) United States
(12) Patent Application Publication
(10) Pub. No.: US 2006/0041830 A1
(43) Pub. Date: Feb. 23, 2006

(54) Method and apparatus for organizing internet information for dissemination to others, collaboration on that information with others, enabling self-publishing of online content and associating it with digital media, enabling contextual search results triggered by playing of digital media

(76) Inventor: Christopher Bohn, Mill Valley, CA (US)

Correspondence Address: Christopher Bohn, 134 Woodbine Drive, Mill Valley, CA, 94941, US

(21) Appl. No.: 10/751,021

(22) Filed: Dec. 31, 2003

Related U.S. Application Data
(60) Provisional application No. 60/437,203, filed on Dec. 31, 2002.

(51) Int. Cl. G06F 17/00; G06F 15/00

(52) U.S. Cl. 715/501.1

(57) ABSTRACT

A method and apparatus for gathering, organizing and disseminating web-based content to others, optionally with the association and display of dynamic metadata. The invention enables the operator to select the URL addresses of data accessible via the internet and group them together into a collection that is stored in a database on a central server that can then be disseminated to others via hyperlink. Metadata such as messages are stored on the central server and can been associated with each member of the collection and can be updated dynamically by the recipients. The hyperlink launches a web browser that retrieves the URL collection and metadata from the server and presents it to the recipient in a navigable apparatus. The invention enables digital media performances to be a nexus for associating and accessing the hyperlinks to launch said collections and for associating additional metadata.

### BRIEF SUMMARY OF THE INVENTION

An embodiment of the present invention is an enhancement to a web browser, and provides methods for gathering and organizing web pages into a navigable, integral apparatus with contextual communications built-in, which apparatus can then be displayed in any web browser. As the user navigates the internet with their web browser, the present invention enables them, at the click of a button, to quickly add the web page currently displayed in the web browser to a “WebPipe”. A WebPipe is collection of web pages selected by the author of the WebPipe; the WebPipe is navigable by clicking sequentially through each page or by jumping to a page via a hyperlink. In addition, message boards and other communication tools are integrated into the WebPipe which allow contextual communications with others who receive the WebPipe. Methods of the present invention also enable a user of said invention to link online content to digital media. For example, the present invention enables a user to create a WebPipe of information about a certain band, and then link said WebPipe to a song by that band. Whenever anyone plays the same song on their computer, that person can view the WebPipe created by the author. For instance, if a user is viewing a web page concerned with income tax issues, the present invention allows for third parties not connected with the web page in question to present their goods or services to the user. In this case, attorneys specializing in tax law can present their services to the user. An embodiment of the present invention enables automatic, context-sensitive search triggered by and relevant to the playing of digital media on a computer.

### BACKGROUND OF THE INVENTION

The present invention relates generally to the field of internet communication, collaboration, and search for relevant document on the internet. More specifically, the present invention is directed to gathering web pages from the internet into a cohesive unit and associating communications by third parties onto those pages, and in providing a new method of obtaining and displaying web page search results.

The internet and the World Wide Web have grown immensely in popularity in recent years. The internet is now probably the largest single information source in the world. Using internet web browsers (such as Microsoft Internet Explorer), users can access information or documents from internet web servers over the internet using the HyperText Transport Protocol (“HTTP”). Internet web browsers provide a convenient user interface allowing the users to receive and display information from internet web servers. Internet web servers are set up and maintained by individuals or companies wishing to publish content on the web. Each web page on the internet contains an unique Universal Resource Locator (“URL”) address. An internet web browser retrieves and displays the document located at a specific URL address. An internet web browser displays only that information which is specified by instructions in the source document specified by the URL address. Often, the instructions in the source document give hypertext links to other documents. Hypertext links are simply instructions to the internet web browser to replace the currently displayed source document with a new document located at another URL address. When the user clicks on the hypertext link, the web browser retrieves the new document from the URL address and displays it to the user. Hypertext links in a web page document are specified by the author of the web page document. If a user wishes to load another document for which there is no hypertext link on the currently displayed document, the user must enter a new URL address manually or by use of a list of saved URL addresses stored in the web browser and known as “bookmarks.”

Often, a person wishes to send an internet web document to another person. This is most often achieved by copying the URL address of the web document into an email, and emailing it to the recipient. When the recipient receives the email, they can then load that URL address into their internet web browser, which will then retrieve and display that web document. If a user wants to direct a user to more than one web document, the user can copy and paste multiple URL addresses into an email and send that on to the recipient or recipients. In this way, a user can share web pages of interest with others. Some browsers also have a built-in command such as “Send Page” which will automatically launch the user's email program with either the URL link or the complete page inserted into the email.

If several users wish to communicate regarding aspects of certain web pages, they must do so in person, using voice communication via telephone, or using email. This becomes clumsy if more than a few users are involved. Furthermore, such methods of communication are difficult since the communication is lacking the web page itself and cannot be referred to easily. It is communication without context.

What is missing from the internet today is a method of packaging up several web pages, regardless of their host domain, into a navigable apparatus, and with contextual communication functionality built-in. The present invention described in this application presents just such a solution, using methods and an apparatus for which the inventor seeks patent claims.

Another problem with the internet today is that it is desirable to self-publish content and and associate the content with digital media files. The present invention presents methods and an apparatus for which the inventor seeks patent claims.

Another problem with the internet is that searching the internet for documents is an explicit act performed at a web site existing for that purpose. The present invention described in this application enables contextual web page information search to be automatically performed in a media player and results displayed therein, thus establishing a new search paradigm that negates the need to visit a web site dedicated to search and to increase accuracy of results by narrowing the search by the context of the digital media being played.

### DETAILED DESCRIPTION OF THE INVENTION

The following detailed description sets forth numerous specific details to provide a thorough understanding of the invention. However, those of ordinary skill in the art will appreciate that the invention may be practiced without these specific details. In other instances, well-known methods, procedures, protocols, components, algorithms and circuits have not been described in detail so as not to obscure the invention.

In one embodiment, the present invention discloses a method and apparatus by which the user can gather the URLs for specific web pages from the World Wide Web, arrange them into a navigable WebPipe, enable contextual communications therein and store the WebPipe for access by others. Furthermore, the present invention enables notes and advertisements that are contextually relevant to specific web pages to be stored in a database and accessed by others.

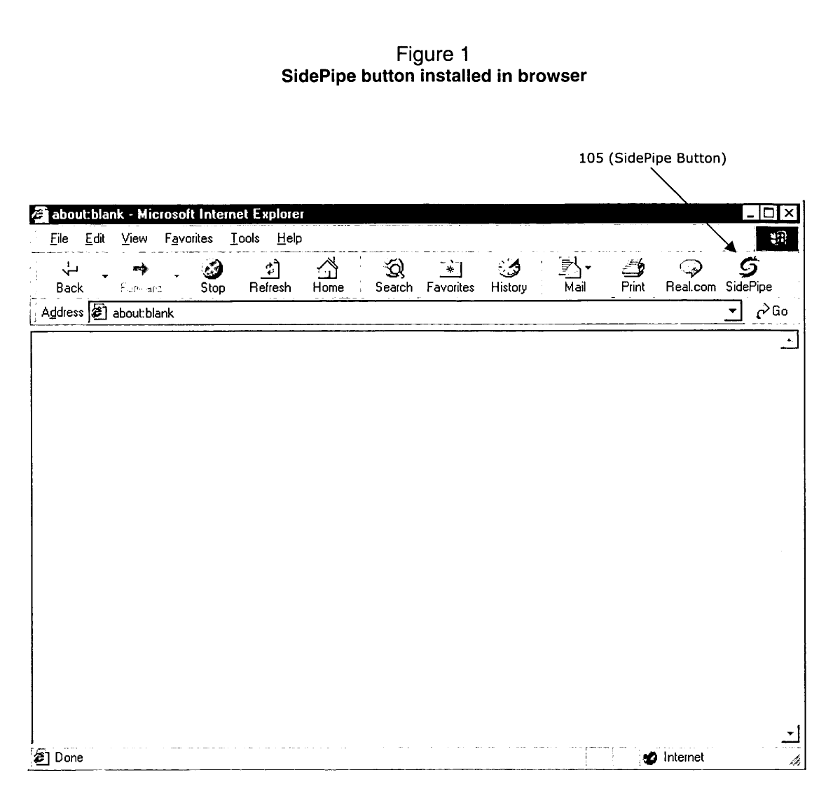

FIG. 1 shows the button 105 to invoke an embodiment of the present invention.

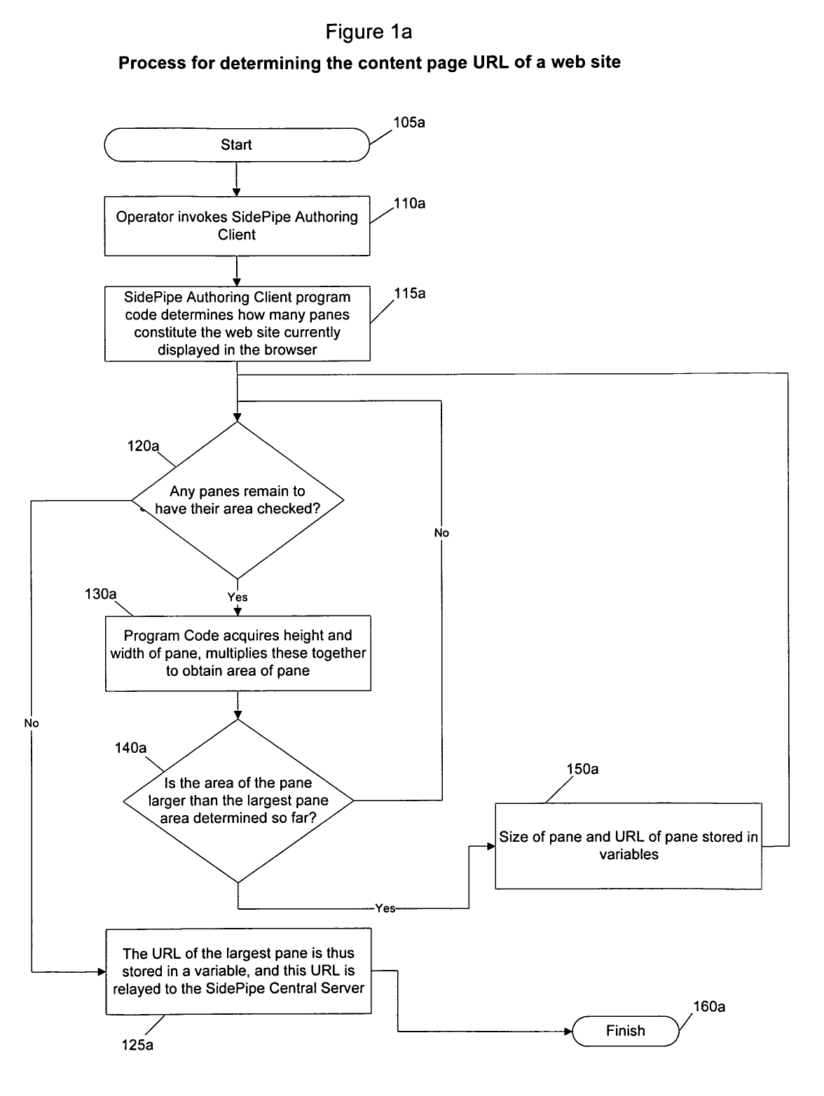

FIG. 2 is an exemplary flow diagram illustrating the authoring process for one embodiment of the invention. In this embodiment, the user decides to create a WebPipe. As the user navigates the World Wide Web with their web browser, they encounter web pages of interest that they wish to add to their WebPipe, as shown in step 210. The user then launches the SidePipe client application as shown in step 215. The user decides in step 220 whether to add the page to an existing WebPipe or to create a new WebPipe. If the user wishes to create a new WebPipe, they do so as such in step 225. The operator then can associate a variety of data with the web page; in one embodiment, the user now gives a name to this page of their WebPipe, and can add comments for the page if they wish; this data is then transmitted via TCP/IP to a central server which stores said data in a database. The user then decides whether to continue the process in step 235. If yes, the process repeats starting with step 210. If not, then the process stops in step 240.

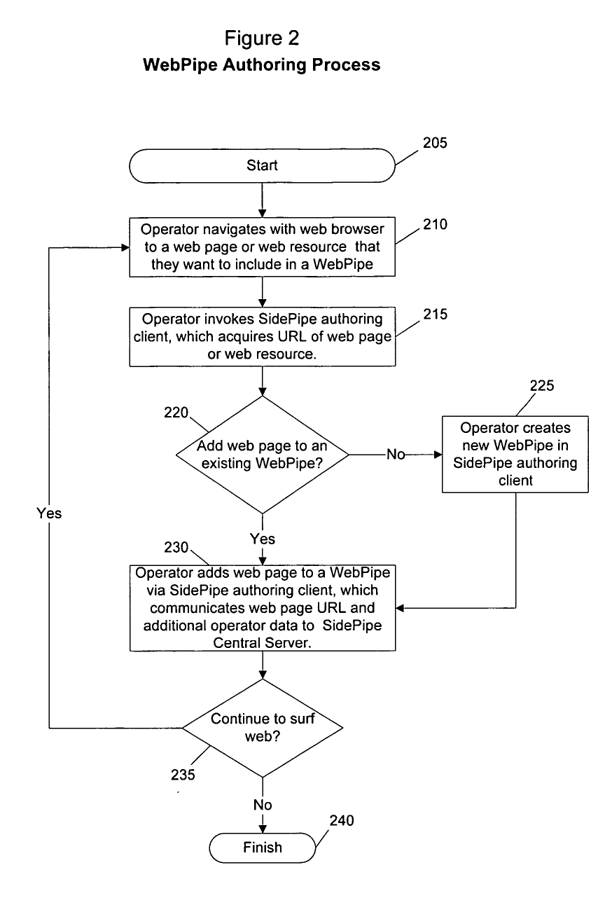

FIG. 3 is an exemplary flow diagram illustrating the user interaction process for one embodiment of the invention. In step 305, the operator is presented with a hyperlink for the WebPipe. In step 310, the operator clicks the hyperlink and a request is relayed via TCP/IP and the HTTP protocol to the SidePipe central server. In step 315, the SidePipe central server software dynamically constructs and formats the beginning page of the WebPipe and returns this data to the operator client browser. In step 325, the operator's browser renders and displays the WebPipe starting page. In step 327, the operator decides whether to load the next page of the WebPipe. If no, then the process proceeds to step 335. If yes, then in step 330 a request is relayed to the SidePipe central server where the software constructs the next page and returns the data to the client browser for rendering and display. In step 335, the operator decides whether to interact with the invention's context data services specific to the current page of the WebPipe. For example, there is a separate message board for each page of the WebPipe. If the operator decides yes, then interacts with said services in step 340. This central server contains a database that contains the URL addresses, page titles and comments which the author of the WebPipe created. The technology then assembles the WebPipe by dynamically building a WebPipe index page. This happens by a database query which retrieves from the database all of the pages of the specified WebPipe. Each page in the WebPipe consists of the URL address of the web page, the user title for that page in the WebPipe and author comments for that page. Also contained in the database is the order in which the pages are to be presented. All of these data are then formatted to display as an index page. Furthermore, the database contains other data relevant to each page. An embodiment of this in the present invention is a message board with which readers of the WebPipe may read messages from others and post their own messages. Many other mechanisms for communication which are relevant contextually to the specific web page in the WebPipe are also envisioned, such as multiple-choice answer forms, polling mechanisms, etc. The common characteristic of these mechanisms is that they enable communication that is relevant to each individual web page in the WebPipe. In step 345 the operator then decides whether to close the WebPipe. If yes, the process finishes in step 350. If no, then the operator returns back to step 327 and repeats the process from that step.

As mentioned, every web page in the internet has a unique URL address. The present invention has a method by which the URL of the web page that the user's web browser is currently displaying can be determined, and communicated to a central server. One of the standard features of a web browser is the ability to “bookmark” a web page URL. A bookmark allows for easy navigation back to that web page, without the user having to remember and type the URL of the web page. One of the limitations of the bookmark mechanism in web browsers is concerned with web pages that are constructed with “frames.” Frames are a structure built-in to the HTML page description language and supported by most internet browsers. Frames allow a web page to actually be comprised of several separate documents. Essentially, frames allow for a web page to be displayed with multiple “panes” with each pane containing a separate document, each document retrieved from an unique URL address. To the user, the web page displayed by the web browser appears as an integral unit. However, as noted, the displayed page is actually a composition of several documents. This is a popular technique used in the authoring of web pages. Often, it is used to simplify the design and user interface of the web site for the user. For a web site that has many web pages and which requires a mechanism for navigation to those pages, the navigation mechanism is often put into a separate pane that remains static and always available to the user. When the user clicks on a navigation link in that pane, the document corresponding to the URL specified by that navigation link is loaded into a separate, neighboring pane. In this way, the navigation panel is a separate unit from the pane displaying the requested document. To the user, the navigation pane remains static and always available, allowing them to select the documents displayed in the other panes.

In HTML (hypertext markup language), the most common language for authoring web pages, frames are specified by a “parent” document which per se specifies the arrangement of panes. The arrangement of the panes is generally called the “frameset” of the web site. When a user loads a web site into their browser, the URL actually specifies the URL of the document that defines the frameset. The URL of this document containing the frameset description is the address of the web site as shown in the URL address display area of the user's web browser. In fact, all of the URLs for the documents that are loaded into the individual panes described by the frameset are obscured to the user. No matter how the user navigates through the web site, the URL displayed in the browser address area to the user remains the same—that of the document describing the frameset. Discerning the URL addresses of the individual documents in the panes is possible, but beyond the abilities of the non-technical user. The problem presented by frames is that when the user bookmarks the page, despite how they have navigated through the web site, it is the URL of the document describing the frameset which is saved. When the user then uses the bookmark which they have stored in their browser to navigate back to that web page, it is the frameset document that is loaded. Since the frameset document specifies only the initial documents to be loaded into its child panes, the bookmarked frameset will always load the top-level starting point of the web site, commonly called the “home page,” regardless of the actual documents loaded into the frameset's panes at the time that the user creates the bookmark. This presents the user with the experience of having navigated to a specific page within a web site which is defined with frames, and bookmarking that page. Upon loading the page, the web browser loads the frameset document, which in turn loads into each pane of the frameset the documents specified in the frameset. This always loads the “home page” of the web site, with all of the initially defined pane documents, instead of the documents that were loaded into the panes at the time that the user created the bookmark. This is an excellent example of the current state of the technology for discerning URL addresses. The current web browsers from vendors such as Microsoft and Netscape all work this way. They discern the governing parent document that gives the frameset, not the individual pages loaded at any one time in the panes.

Web browsers do have knowledge of all of the URL addresses of documents loaded into the individual panes of a web site that uses frames. However, the current state of the art does not enable the identification of the key content document currently displayed. For example, consider a web site using frames which has a frameset which specifies two panes: a small pane on the left giving navigation links and a larger pane on the right which displays the “content document” specified by the links in the left pane. The current state of the art does not allow for identification of the pane that contains the content document. To the web browser, there are simply two panes, each displaying a document identified by a URL address. The present invention furthers the art by giving a method by which the content page is discerned. This method is now described.

The method works off of the observation that the pane that displays the content document is almost always the largest pane in the frameset. It is a phenomenon that the designers of web sites that use frames design the frameset that describes the geometry and relationship of the panes within it to give maximum area to the content document. Thus, the URL of the key content document is that which is currently displayed in the largest pane of the frameset. The present invention determines which of the panes in the frameset has the largest area, and then retrieves the URL for the document. The present invention then communicates that URL address to a central server. Since the URL address of a publicly available web document is by definition unique, that URL can serve as a key in a relational database. The database can then relate other data to that key. The present invention uses database keys derived from the unique URL addresses to associate relevant data, such as a message board, to web pages.

FIG. 1a is an exemplary flow diagram illustrating the process whereby the content page URL of a web site is determined. The process starts in Step 105a. The operator invokes the program code in step 110a. In step 115a, the program code determines the number of panes in the web site. In step 120a, the program code determines if any more panes need their area calculated. If yes, in step 130a the program code acquires the height and width of the pane and multiply these together to get the area of the pane. In step 140a, the area of the most recent pane is compared to the largest of all previous pane areas. If the area is largest, then the URL and the pane area are stored in variables in step 150a, thereafter proceeding back to step 120a to repeat the process. If the area is not largest, then the process also loops back to step 120a. If in step 120a no further panes are to be checked, then the process goes to step 125a. The URL stored in the variable in step 150a is thus the URL of the pane with the largest area. This data is relayed to the SidePipe Central Server. The process then finishes in step 160a.

An embodiment of the present invention is a button that is added to the web browser. This is shown in FIG. 1. This button, when clicked, is an event that invokes the method that determines the URL of the content page. Those with ordinary skill in the art will recognize that other embodiments could have different event triggers other than the button described herein, and which is the preferred embodiment. For example, the method could also be invoked by the action of pressing a certain keyboard key combination or a uttering a specific voice command. Regardless of how the method is invoked, the resulting URL of the content page as determined by the method is then transmitted to the central server. In an embodiment, the method invoked by the button also launches a small client window on top of the current browser window. This is called the “SidePipe Client.” The SidePipe Client is the apparatus by which the user determines what other methods of the invention should be invoked. An embodiment of the present invention allows for three general functions: Add the URL to a WebPipe, access or create notes that are associated to that URL, or access other data that are contextually relevant to that URL (such as advertisements from third parties). Each of these functions will now be described in turn.

As described earlier, the user first navigates to a web page to which they wish to apply the present invention. Once the web page is loaded and displayed in the user's web browser, the user invokes the SidePipe Client. An embodiment of the present invention has said invocation achieved by the clicking of a button installed on the web browser. When clicked, the button does two things: 1) It invokes the process described above wherein the content page URL is discerned by calculating the area of each pane. The largest pane is considered to hold the URL of the Content Document; 2) It opens a new browser client window, called the SidePipe Client, on top of the current browser window, with data and documents retrieved from a central web server to which the URL of the Content Document has been transmitted. The client window that opens stores the value of said Content Document URL as a variable that is accessible to the SidePipe Client. The SidePipe Client can then retrieve this URL value as needed to transmit to the Central Server as part of client/server function calls.

When the SidePipe Client is launched, then, it has knowledge of the Content Document URL that was in the web browser when the user first invoked the SidePipe Client. At this point, the user has discretion as to which of the SidePipe Client functions the user wishes. In an embodiment of the present invention, the user has three choices, which are covered by three general function types: WebPipes, WebNotes, and Associated Services. Each of these general functions is now described in detail.

In one embodiment of the present invention, the “WebPipe” is The WebPipe is composed of four key components:
1. Index page giving the contents of the WebPipe.
2. The URLs of the pages in the WebPipe
3. The author-generated content for each page in the WebPipe
4. Communication data for each page in the WebPipe

The WebPipe author creates the WebPipe within their browser experience. As the author views web pages with their browser, they may find pages that they wish to include in a WebPipe. The first step for the author is to navigate to the web page that they wish to add to a WebPipe. With the desired web page loaded and displayed by the author's web browser, the author then invokes the program code for the present invention. As noted above, an embodiment of this is by the method of clicking a button that has been downloaded and installed on the user's web browser. Upon clicking this button, the program code of part of the present invention is invoked. As described above, the code discerns the Content URL of the presently loaded web page (via the process described above). In an embodiment of the present invention, a client browser window is then loaded on top of the current browser window, with content supplied by the central SidePipe server, to which the URL discerned by the code invoked by clicking the SidePipe button has been supplied. Thus, the SidePipe client window that launches on top of the current browser window contains the Content URL as a value assigned to a variable within the SidePipe client browser window. That URL can then be accessed by the SidePipe client browser to be passed back to the Central Server as needed.

In the creation of the WebPipe, the user first creates a named WebPipe. When the author first creates a WebPipe, and assigns a name to it, that name is transmitted to the Central Server and the appropriate entries are made in the SidePipe databases. In the present embodiment of the invention, there is the concept of the “current active WebPipe.” This is a user interface technique used to make additions to the WebPipe quicker. The author in general will tend to focus on completing one WebPipe at a time, and the “current active WebPipe” approach enables the author to quickly add web pages to a WebPipe without having to always specify the WebPipe to which each page is to be added.

In an embodiment of the invention, the user, by clicking the “add page to pipe” command in the SidePipe client window, adds the URL of the Content Page as discerned by the Launch Code, to the Current Active WebPipe. The user is then presented with the opportunity to add a descriptive title to that page in the WebPipe, and to add any descriptive notes to that page. The “Page Title” and “Page Note” will be part of the WebPipe, able to be read by the recipient of the WebPipe. After entering the Page Title and the Page Description, the author clicks the “submit” button. The SidePipe Client then transmits the URL, Page Title, Page Description, Page Number, User handle, and User Password to the Central Server. Using standard relational database methods, the Central Server code first verifies the User Password matches the User. If yes, then the code adds the URL, along with the Page Title and Page Description, to the database. Furthermore, the order of the page within the WebPipe, which is specified by the Page Number, is also set in the database. At this point, the author is finished with adding this page to the WebPipe. They can now close the SidePipe Client and return to surfing the web, and to add another page to a WebPipe using the method described above.

The present embodiment of the invention allows for other commands relevant to the creation of WebPipes. These other commands are:
View Pipe. Launches the WebPipe in a separate, full-size browser window so that the author can play the Current Active WebPipe, and thus experience the WebPipe as a recipient would.
Email Pipe. This command, through standard techniques familiar to those with ordinary skill in the art, launches the author's email system, with an email message with the link to the WebPipe pre-written and ready to be sent to the recipient.
Delete Pipe. This command sends a message to the Central Server to delete from the database the user's current active WebPipe.

In addition, the individual pages in a WebPipe may be edited. The author can delete any page completely from the current Active WebPipe. They may also edit the Page Title and Page Description that they entered for a specific page in the WebPipe. The author can also re-arrange the order of the pages in the WebPipe.

An important feature of the WebPipe playback apparatus is that it is entirely HTML-based, and requires no supplemental software be installed on the user's computer to view the WebPipe. The WebPipe Viewer is constructed dynamically by the SidePipe Server and is accessed through a URL input into the browser, either manually typed or through clicking a hyperlink. The WebPipe Viewer thus behaves like any other dynamic web document. The URL for the WebPipe contains name/value pairs that are passed to the SidePipe Server. In the present embodiment of the invention, these name/value pairs are: The ID number of the WebPipe which the SidePipe Server uses to get the proper data from the SidePipe Server Database relevant to the specific WebPipe; a key value which in combination with the ID number are unique and used for validation; and a “Skin ID” which is used by the SidePipe Server program to set the branding and look and feel of the WebPipe Viewer.

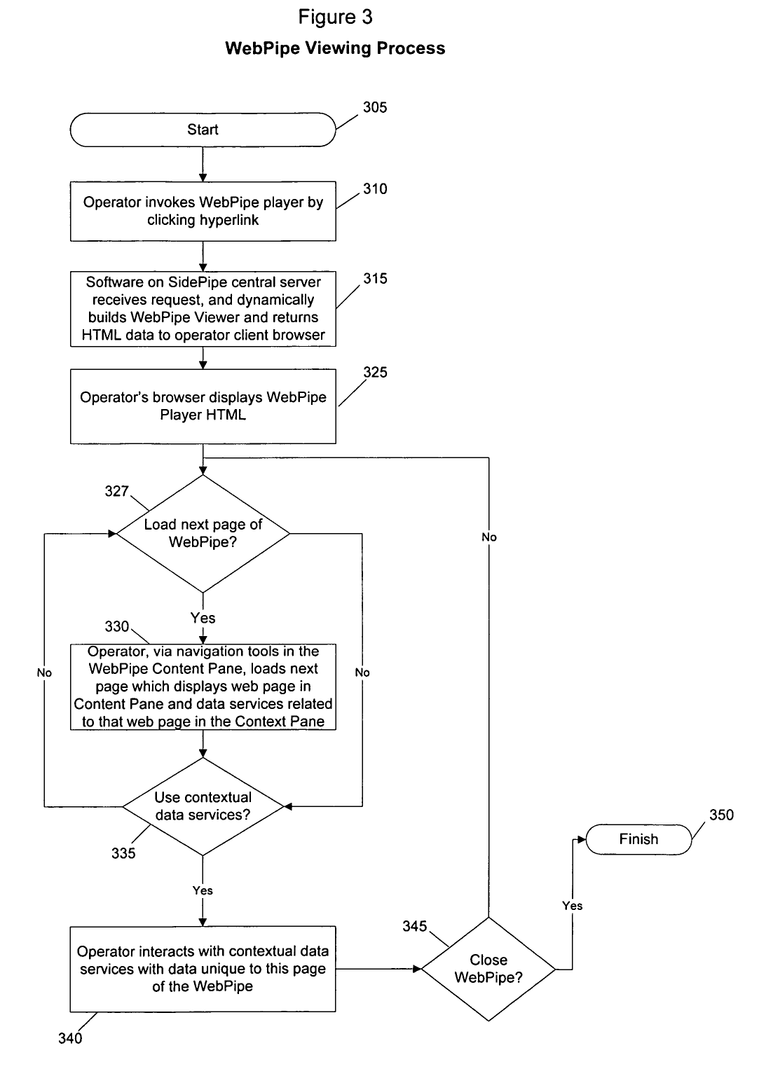

When the user loads a WebPipe for viewing, the SidePipe Server uses the name/value pairs provided in the URL to perform queries on the SidePipe database, and to retrieve the data specific to that WebPipe. In the present embodiment of the invention, that information includes the URLs of the web pages that were added to the WebPipe by the WebPipe Author, and the title and that the WebPipe Author added during the WebPipe creation process. These data are then assembled into an index and listed in tabular format. In the present embodiment of the invention, the WebPipe Viewer consists of three distinct parts: A “Navigation Pane” which enables the user to navigate through the WebPipe; a “Content Pane” which displays the web pages that the WebPipe Author put into that specific WebPipe; and a “Context Pane” where data such as message boards are displayed. These three distinct parts are shown in FIG. 4.

When the WebPipe is loaded into a user's browser, the initial appearance has the index page that has been constructed by the SidePipe Server displayed in the Content Pane. This enables the user to view the title and description of the WebPipe as created by the WebPipe Author. In addition, the title and description of each page in the WebPipe, as created by the WebPipe Author, is listed. These page listings are constructed as hyperlinks that allow the user to jump to any page in the WebPipe. FIG. 4 also shows the Navigation Pane that gives controls for moving serially forward or backward through the WebPipe. The “Index” button returns the user to the start of the WebPipe with the index page loaded in the Content Pane. These controls thus give the user navigational power to move forward or backward through the WebPipe, or to jump to any specific page.

After the initial index page, the user then navigates through the WebPipe. When the user navigates to a new page in the WebPipe using the methods described above, a command in the form of name/value pairs and transmitted via standard HTTP methods is sent to the SidePipe Server. The SidePipe server then queries the SidePipe Database and retrieves the data associated with that page in the WebPipe. In the present embodiment of the invention, the SidePipe Server then provides updated data to two of the panes in the WebPipe Viewer: The Content Pane is directed to load the web page located at the URL that WebPipe Author added during the authoring process. That web page is then loaded directly from whatever web server responds to that URL address. Since the web page shown in the Content Pane is served directly from the source web server, the content of that web page is not guaranteed to be the same as it was when the WebPipe Author added that web page to their WebPipe in the authoring process. This is beneficial in that time-sensitive web pages, such as those providing news articles and other timely matter, will be up-to-date whenever the WebPipe is viewed. For example, the WebPipe Author could create a WebPipe consisting of news sources, and even if the WebPipe is viewed far into the future from the date of creation, the content will be up-to-date. The other pane that gets updated by the SidePipe Server is the Context Pane. The SidePipe Server Database, using standard relational database techniques, associates specific data that resides on the SidePipe server with the URL of the web page displayed in the Content Pane. In this way, data objects such as message boards can be displayed in the Context Pane that are specifically relevant to the URL of the web page shown in the Content Pane. During the WebPipe authoring process, the WebPipe Author associates a title and description with each web page that they add to a WebPipe. That data is stored in the SidePipe Database on the SidePipe Server, and using standard relational database techniques, those data are associated with the web page. Upon playback of the WebPipe, the SidePipe Server is thus able to populate the Context Pane with data relevant to the web page displayed in the Content Pane. In the embodiment of the present invention, a message board is one of the data types that the WebPipe Author can optionally specify appear in the Context Pane of every page in the WebPipe. As a recipient of a WebPipe progresses through the WebPipe, a separate and distinct message board appears in the Context Pane. Every recipient of the WebPage sees the same message board, thus allowing collaboration between different persons viewing the same WebPipe. Furthermore, each page in the WebPipe has a separate and distinct message board. Thus, a WebPipe that consists of three pages has three separate and distinct message boards, one for each page of the WebPipe. Since the message board in the Context Pane is shown while the web page is shown in the Content Pane, all recipients of the WebPipe see both the message board in the Context Pane and the web page in the Content Pane simultaneously. Other data types besides message boards can be placed in the Content Pane, and like the message board, any other data is also likewise stored on the Central Server.

An embodiment of the present invention is an enhancement to a software program known as a “media player” which purpose it is to play audio files or show video clips on the user's computer. Most media players for computers are designed to accommodate enhancements through a “plug-in architecture” which allows third parties to enhance and extend the functionality of the media player. The present embodiment of the invention is an enhancement to the media player and inserts a web browser control into the media player. The web browser control provides a region in which HTML documents can be displayed. The present embodiment of the invention displays a web page assembled by the SidePipe Central Server. When the user plays an audio file or video clip in the media player software, the present embodiment determines, through the API (Application Program Interface) provided by the media player software, specific information about the media currently playing. Such information is referred to as the metadata of the media file. The metadata includes the artist or author of the content, the name of the content, and other data appropriate to type of media file. For example, an MP3 audio file usually contains metadata for the artist, song title, album, year, and genre. The invention obtains this information from the media player software through its API, and this data is then transmitted to the SidePipe Central Server.

The present embodiment of the invention uses the metadata information in its method of associating external content with the media file. An embodiment of the invention has a relational database program running on the central server. This database essentially preserves associations between media files and independent content. We will now describe the organization of the database tables that accomplish that. Those with ordinary skill in the art of database design will recognize that there are designs of the database that could yield similar results, and the design herein described is not intended to limit the scope of the invention. The present embodiment creates relational database tables to associate content with the media file. The media file thus becomes a nexus through which other media can be associated and accessed. uses the author and title of the media to form the key, but other metadata could also be used. For example, many audio files contain a metadata field with a unique identification number. Since it is unique, this number could also be used as the key. However, the use of such identification numbers at present is not universal. Thus, the present embodiment uses a key constructed from the author and title. Consider the song “Hey Jude” by “The Beatles.” This artist and song title, considered together, form an identification that gives a very high degree of uniqueness. This pair allows the present embodiment to form query parameters to extract data from a relational database. The present embodiment contains a relational database table that has fields that correspond to the standard metadata tags present in the media files. For audio files, those metadata tags are artist, title, album, genre and year. Within that table there is a field that contains a list of the identification numbers of WebPipes that are associated with that particular media file. For example, let's say that the WebPipes with ID numbers of 345 and 676 have been associated with the song “Hey Jude” by “The Beatles”. If we perform a query on the database, we can ask the database to return the list of WebPipes where artist=‘The Beatles’ AND title=‘Hey Jude’. The database will return the list [345, 676]. Further refinement is also possible on the query, since songs are often part of albums. For example, the song “Hey Jude” by “The Beatles” was issued as a single, but it is also found on the albums “Hey Jude”, “The Beatles 1967-70” and “The Beatles Past Masters Volume 2.” Thus, “album” can be an additional field in the database that we can use to further refine the search. We could, for example, query the database and ask for the list of WebPipes for which artist=‘The Beatles’ AND title=‘Hey Jude’ AND album=‘The Beatles 1967-70’. The resulting list would not necessarily be the same as the list provided by a query using just artist=‘The Beatles’ and title=‘Hey Jude’. This method of associating a list of WebPipes with songs in this way enables differentiation between versions of songs, particularly with live albums that have the same song titles as studio releases, but are actually different performances.

In one embodiment, the invention provides for several types of data to be associated with a media file. These are WebPipes, messages boards, blogs and promotional pieces. These are each described in turn.

WebPipes have been fully described above. In this embodiment, the operator is shown a list of WebPipes that others have associated with the media that they are currently playing in their media player software. The operator is also given the opportunity to associate any WebPipes that they have created with that media file. Thus, a list of the WebPipes that they have authored is displayed. A checkbox is located next to each WebPipe listing, the purpose of which is for the operator to indicate which WebPipes they want associated with the media.

Message boards are a common mechanism on web sites. The software architecture of message boards traditionally is that the topic of a message board thread is usually the key to finding the messages that belong to the thread. The present invention instead uses the metadata tags as fields to pre-filter the message topics. When an operator is playing media in their software media player, the metadata of the currently playing media is transmitted to the Central Server, along with the mode of the invention. If the mode is “message board” then a database query is performed, requesting all message board topics where the artist and title match. The resulting topics are then assembled in order of most recent and transformed into table format and sent to the client for display to the operator. In this way, only topics that were posted by the operator or others during the playing of that media are displayed. When the operator clicks on a topic, all of the messages posted to that topic are then displayed. The topic id code is transmitted to the Central Server, which then performs a database query to assemble all messages, in order of most recent, of messages posted to that topic. Every message occupies a row in the messages table. One of the fields of that table is the topic id. If the operator creates a new topic, the name of the topic, along with the metadata of the current playing media, is transmitted to the Central Server. In the ‘Message Board Topics’ table, an entry is made. The fields of this table consist of the metadata tags from the media, plus a unique integer id field created by the database. When a message is posted under a topic, the message, author and topic id are transmitted to the Central Server. An entry is then made into the ‘messages’ table, with the topic id enabling the message to be extracted as part of the results of a database query where the topic id is the parameter of the query.

All data types follow this method. The key point is that a table exists where there is a field for each of the metadata tags in a media file type. Those metadata tags, all or in part, are used as parameters to extract a list of content units that are associated with that media. In the present invention, the extracted list is a list of keys into other database tables that contain the actual data. Those skilled in the art will recognize that there are other ways to arrange the database tables to achieve the same end, but that using the metadata tags as fields in the database table to organize the data and perform queries will be the same.

Digital media files such as audio files and video files are played on a computer using a media player. Media players generally provide the ability to enhance their capability by installing a plug-in. A plug-in can be developed either by the vendor who makes the media player, or by third parties if the vendor provides a development kit for their media player. The development kit usually documents the Application Program Interface (API) which describes the services that the main program provides to a plug-in, and how a plug-in should interact with the host program. An embodiment of the present invention is a plug-in for media players which enables a central server to provide the plug-in with additional content resources appropriate to the currently playing media item. The present invention listens for events such as a new media item beginning to play. The present invention then acquires, through API calls, the metadata from the currently playing media item. This metadata is then transmitted to the central server. The central server performs a database lookup to see if any content resources have been associated with the currently playing media item. The associations are stored in a relational database. The metadata consists of several fields of data. For example, audio files usually contain fields for artist, title, album, genre and year. The present invention duplicates the same fields in its relational database tables. When an association is made, those fields in the relational database are populated with the metadata field values. This enables a database retrieval of data associated with a particular media file.

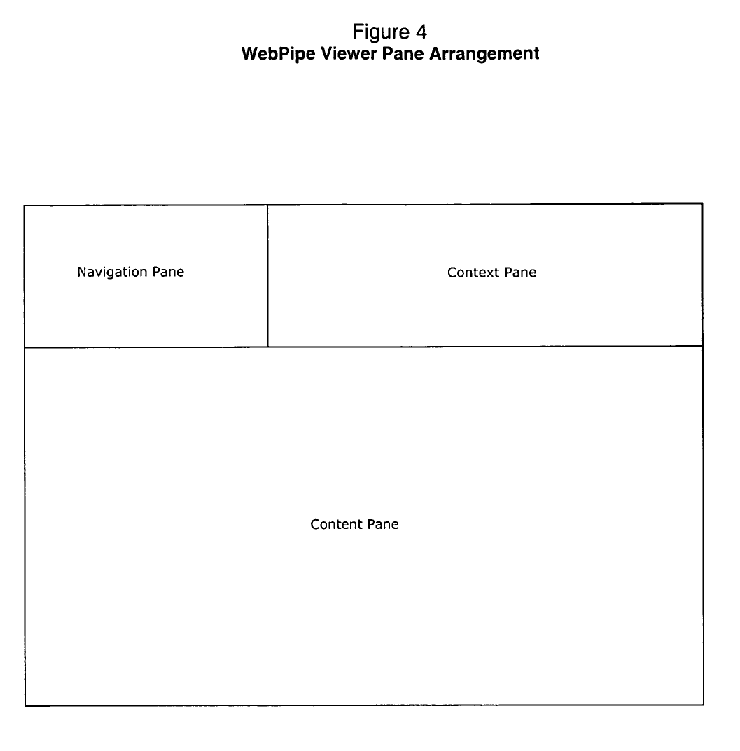

FIG. 5 is an exemplary flow diagram illustrating the process whereby an embodiment of the present invention dynamically retrieves data associated with a digital media performance and enables the operator to associate their own data with the digital media performance. The process starts in step 505. In step 510, the operator runs a software program known as a “media player.” In step 520, the operator plays a digital media performance in the media player. In step 530, the present embodiment acquires the metadata for the currently playing digital media performance. Such metadata includes the name of the piece and the performer amongst other data. In step 540, the present embodiment relays the metadata and a data specification request to a central server. The central server uses the metadata to form a query to retrieve data that has been associated with that digital media performance. The query is further refined by the data specification request. For example, the data specification request may call for just data that has been associated by certain other individuals be retrieved. In step 550, the central server formats the retrieved data and relays the formatted data back to the media player present embodiment enhancement plugin, which renders and displays the data to the operator in step 560. In step 570, the operator then decides whether to associate their own data with the currently playing digital performance. For example, the operator may wish to reply to a message that another person had previously associated with the digital media performance. If the operator thus decides “yes” in step 570, then in step 572 the operator prepares the data. In step 574, the operator data, metadata of the digital media performance and data specification are relayed to the central server. In step 574, the central server prepares a database query that uses the operator data, metadata and data specification as parameters in a database query that inserts the operator data into the database. The query is executed in step 578. The process then returns to step 550 described above and the process continues. If the operator in step 570 does not wish to associate any of their own data with the digital media performance, then they proceed to step 575 where the current digital media performance ends. In step 580, the operator may decide to play another digital media performance. If yes, then the process loops back to step 520. If no, then the process ends at step 590.

Search engines are an essential part of the internet browsing experience. Search engines catalog all of the web pages on the internet, and associate them with keywords. A typical search engine sessions goes as follows: A search engine user goes to the search engine web site, types in their keyword(s) and the search engine then returns a list of web pages in which the keywords appear. Through the use of boolean operators, searches can be narrowed. The problem is that searches are performed without any context, and results are not as accurate as they could be. An embodiment of the present invention provides for an improved search paradigm. The present invention takes advantage of the fact that knowing the context of a search can greatly improve the results. As mentioned, an embodiment of the present invention is a plug-in for media players. When a media asset is played, such as an audio file, the present invention obtains the metadata for the media asset. In the case of an audio file, the present invention obtains the artist, title, album, genre and year. Often, not all of those fields contain data. However, they almost invariably contain the artist and title data at a minimum. Since we know the context (the artist and the title of the song), we now have context to perform highly accurate searches. Furthermore, since we have context, we can anticipate the types of searches most users will do. With regard to music, most listeners will perform searches to find web pages that give them information about the artist and the song. That is, information about the artist such as how many other songs they have made. Much of the best information comes from a relatively small number of web sites. These web sites are mostly online versions of print publications, such as rollingstone.com and vibe.com. The present invention takes advantage of the fact that to navigate to a page about a specific artist, one must at one point click on a hyperlink that gives the artist's name. All search engines use what is known as a “spider” to find out information on web sites. A spider is software that is programmed to automatically visit a plurality of web sites and to retrieve a plurality of web pages from those web sites. The spider software functions in an automated manner by retrieving the top-level page of a web site, known as the home page, building a list of all hyperlinks on the page, then retrieving each web page referred by the links and repeating the process. In this way, the spider descends through the hierarchy of all pages in the web site and retrieves all pages in the web site. Those retrieved web pages are then converted into structured data that is entered into a database on a central server, the database being searchable for keywords that appear in the web pages. The database is organized such that the URL of the document that contains the keywords input as search parameters can be determined. Search engines thus retrieve from the database all of the URLs of documents that contain the keywords input by the operator. A search engine will then arrange the list of URLs and format them so as to be displayable in a web browser. An important point to consider about the usage paradigm by an operator using the search engine software is that the input of keywords is a manual operation, and that going to a search engine web site is a conscious action of the operator.

The present invention alters the traditional search paradigm by spidering only those web sites known to have particular relevance to the media files. Again, taking our music file example, the present invention spiders such music sites as rollingstone.com, vibe.com, mtv.com, allmusic.com and others. The spider then, as other spiders do, obtains a list of the hyperlinks on each page and retrieves other pages in the web site. As mentioned, the hyperlink to a specific artist page is usually labeled with the artist's name. Furthermore, navigation hyperlinks to those web pages concerning a specific artist are usually listed on a single index page, or a series of index pages. The present invention takes advantage of that by first retrieving the index page, or the starting index page if there are a series of them. The present invention then retrieves all hyperlinks on the index page, and stores them in a database for later retrieval.

The site map contains some basic information about the web site including how the web site groups its pages and how it encodes its hyperlinks to pages containing information for a specific artist, song, album, or genre. The site map remains the same as long as organization of the web site remains unchanged. In one embodiment, the URLs of web pages that contain information specific to an artist, song, album or genre of music are stored in a database, along with the name of the artist, the name of the song, the name of the album, the type of genre, in whatever combination is appropriate for the hyperlink. In order to ensure that the hyperlinks are up to date, a web site may be visited periodically.

An embodiment of the present invention is concerned with the organization and presentation of content resources relevant to specific digital media. Every digital media type has certain specific metadata fields that have special meaning. For example, the primary metadata fields pertaining to digital audio media may be comprised of the artist, song title, album title, genre, and year fields. The primary metadata fields for video files may be comprised of title, leading cast, secondary cast, producer, director, genre, rating, and year. Since different media file types have different metadata fields, this presents a problem with the organization of a database that can store and retrieve metadata fields in a generic sense and be applicable to different media types. The present invention resolves this by creating a media type map, which maps the specific metadata fields appropriate for a specific media type to generic metadata fields in a database. The database has n number of generic metadata fields, which may be labeled metadata_{—}1 through metadata_n, n not being limited in theory but in practice being between 5 and 10. Taking as an example the audio media type, the media type map for audio type media would map the field of artist to the metadata_{—}1 field in the database, the field of song title to metadata_{—}2 field, the field of album to metadata_{—}3, the field of genre to metadata_{—}4, and the field of year to metadata_{—}5. All other fields in the database beyond those mapped by the media type map would contain empty values. Thus, if the database has 10 metadata fields, in the example of the audio media type, the database fields metadata_{—}6 through metadata_{—}10 would have empty values. If we apply this to the video media type, the video media type map would map the metadata fields for the video type media of title, leading cast, secondary cast, producer, director, genre, rating, and year to database metadata fields metadata_{—}1 through metadata_{—}8, respectively. All other database metadata fields beyond metadata_{—}8 would contain empty values. In this way, the present invention is able to apply methods to store, retrieve and process database entries that are agnostic with regard to the media file type.

The following is an example of the media type map code to describe the mapping of audio file types to the database:

audio_file_map = {

“database field mapping” : {

“metadata_1” : “artist”,
“metadata_2” : “song title”,
“metadata_3” : “album title”,
“metadata_4” : “genre”,
“metadata_5” : “year”,

},
“field grouping” : [(“artist”,), (“artist”, “song title”), (“artist”, “album”),

(“artist”, “song title”, “album”), (“genre”,), (“year”,),
(“genre”, “year”)],

}

The media type mapping is here constructed as an associative array, a data structure known to those with ordinary skill in the art. However, those with ordinary skill in the art will recognize that there are other common data structures that could represent the media type mapping. The associative array structure given here is not meant to limit the scope of the present invention, but to give a common structure know to those with ordinary skill in the art to the media type map for the purpose of describing the media type map. There are two aspects to the media type mapping language, the database field mapping and the field grouping. In the example above, the entry “database field mapping” specifies the mapping of metadata fields specific to the audio media type to the generic database metadata fields. The entry “field grouping” specifies which fields either alone or in combination have relevance to the media type. In the example above, the groups given are the following list: [(“artist”,), (“artist”, “song title”), (“artist”, “album”), (“artist”, “song title”, “album”), (“genre”,), (“year”,), (“genre”, “year”)]. Those with ordinary skill in the art of programming will recognize that this is a list of tuples. A tuple is a common data structure that is immutable and thus can be hashed and used as a key in a hash table. This creates a type of database wherein data is stored and retrieved by means of the unique, hashable tuples given above. For example, consider an the song “Hey Jude” by the artist “The Beatles”. This song is from 1969, is a rock song, and was available as a single and on the albums “Hey Jude”, “The Beatles 1967-70” and “The Beatles Past Masters Volume 2.” the resulting data structure would look like this:
(“The Beatles”,): [list of database Ids with matching metadata fields . . . ],
(“The Beatles”, “Hey Jude”): [list of database Ids with matching metadata fields . . . ],
(“The Beatles”, “Hey Jude”, “Hey Jude”): [list of database Ids with matching metadata fields . . . ],
(“The Beatles”, “Hey Jude”, “Past Masters Volume II”): [list of database Ids with matching metadata fields . . . ],
(“The Beatles”, “Hey Jude”, “The Beatles 1967-1970”): [list of database Ids with matching metadata fields . . . ],
(“The Beatles”, “ ”, “ ”, “ ”, “1968”): [list of database Ids with matching metadata fields . . . ],

Thus, if we wanted a list of all URLs for web pages from select web sites that have information relevant to the song “Hey Jude” by “The Beatles”, we could simply retrieve the list from this data structure that is associated with the tuple (“The Beatles”, “Hey Jude”). If we wanted a list of the URLs for web pages from select web sites that have information relevant to the “The Beatles” in the year “1968”, we would retrieve the list associated with the tuple (“The Beatles”, “ ”, “ ”, “ ”, “1968”). With this method, we can retrieve lists for many combinations of parameters. This also makes it possible for the present invention to automatically create and populate web pipes with URLs to web pages specific to a set of parameters appropriate to the media type. This data structure is hereafter referred to as the “parameterized data”.

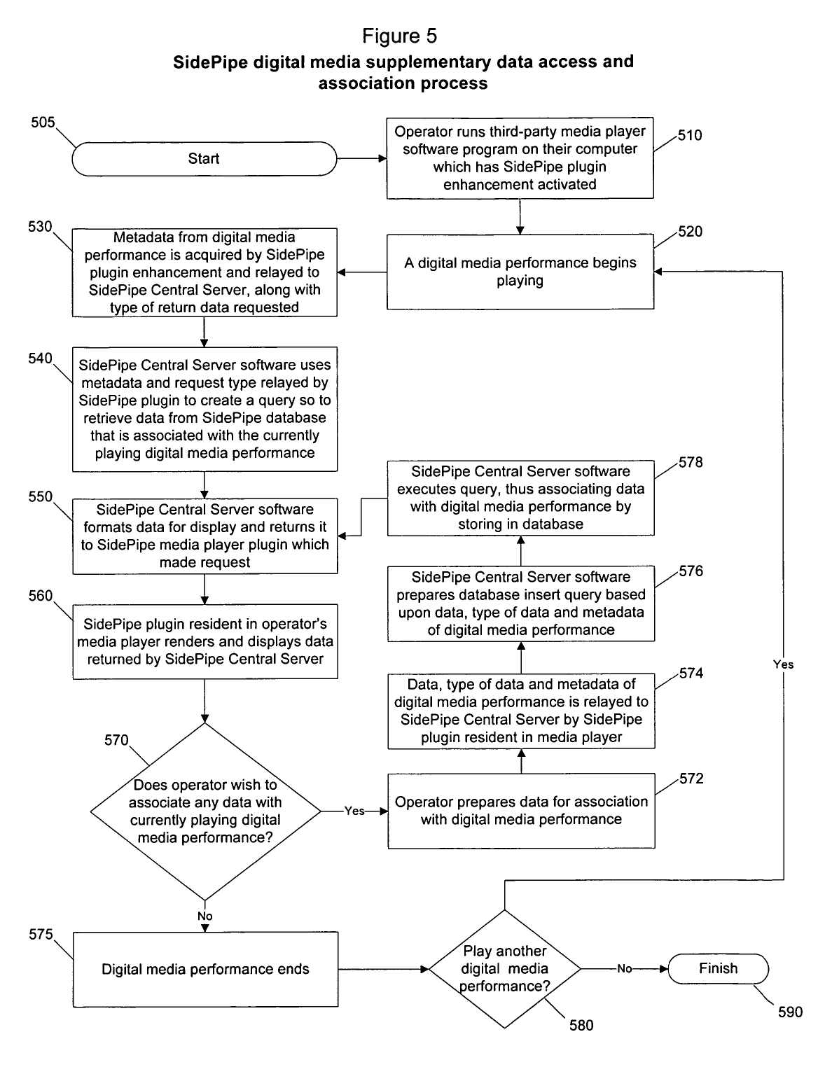

FIG. 8 is an exemplary flow diagram illustrating how web pipes can be automatically created and populated with URLs from the parameterized data described above. In step 205, all of the keys to the parameterized data are retrieved. In step 210, the list associated with each key in the parameterized data is then retrieved, with the list consisting of the IDs of entries in the database tables. In step 215, a WebPipe is created. In step 220, the URL for each entry in the database table with the ID present in the list of IDs retrieved from the parameterized data are added to the WebPipe.

What is claimed is:

1. A method, comprising:
a) gathering a plurality of content document URLs originating from a plurality of web sites;
b) displaying the content document URLs in a WebPipe;
c) associating supplementary content to each.

2. The method of claim 1 wherein the URL of a content document is what is currently displayed in a web browser.

3. The method of claim 2 wherein determining the content document URL in the web browser comprises evaluating the area of each browser child window and using the URL of the document displayed in the largest client window as the content document URL.

4. The method of claim 3 wherein the content document URL is transmitted to a central server.

5. The method of claim 1 wherein the organization of the content document URLs is done by a database program on a server.

6. A method comprised of:
a) obtaining the metadata of a digital media file;
b) transmitting the metadata to a central server;
c) using the metadata to associate content with the media file or copy thereof.

7. The method of claim 6 further comprising creating a plug-in enhancement to a digital media player, the plug-in obtaining the metadata of the digital media file.

8. The method of claim 6 further comprising:
a) associating operator content with a digital media file;
b) launching content that has been associated with the digital media file.

9. The method of claim 6 further comprised of:
a) retrieving content resources associated with a particular digital media file;
b) displaying the content resources associated with a particular digital media file.

10. The method of claim 9 further comprised of using the metadata obtained from the digital media file as parameters in a database query to retrieve content resources associated with the digital media.

11. The method of claim 9 further comprised of the server computer transforming the content resources, once retrieved, into a format suitable for access on the client computer and transmitting the content resources to the client computer.

12. The method of claim 11 further comprised wherein the format used to display the content resources is a WebPipe, the WebPipe being an apparatus for navigating through a set series of URL-addressed resources with additional features.

13. A method comprised of:
a) creating a list of topics
b) harvesting a plurality of content document URLs from a plurality of web sites;
c) associating the harvested URLs, based on the content of the document referred to by each URL respectively, to the appropriate topic;
d) assembling the topics and the URLs therein into a format capable of being transmitted and viewed on a client computer.

14. The method of claim 12 further comprised of having a listing of topics relevant to a specific digital media instance automatically retrieved by a client program and automatically displayed to the operator upon the operator's playing of the specific digital media file.

15. A method of claim 14 further comprised of having the results presented in a WebPipe.

16. A computer readable medium containing instructions which, when executed in a processing system, causes the processing system to perform a method comprising:
d) gathering a plurality of content document URLs originating from a plurality of web sites;
e) displaying the content document URLs in a WebPipe;
f) associating supplementary content to each.

17. A computer readable medium containing instructions which, when executed in a processing system, causes the processing system to perform a method of claim 1 wherein the URL of a content document is what is currently displayed in a web browser.

18. A computer readable medium containing instructions which, when executed in a processing system, causes the processing system to perform a method of claim 2 wherein determining the content document URL in the web browser comprises evaluating the area of each browser child window and using the URL of the document displayed in the largest client window as the content document URL.

19. A computer readable medium containing instructions which, when executed in a processing system, causes the processing system to perform a method claim 3 wherein the content document URL is transmitted to a central server.

20. A computer readable medium containing instructions which, when executed in a processing system, causes the processing system to perform a method of claim 1 wherein the organization of the content document URLs is done by a database program on a server.

21. A computer readable medium containing instructions which, when executed in a processing system, causes the processing system to perform a comprised of:
d) obtaining the metadata of a digital media file;
e) transmitting the metadata to a central server;
f) using the metadata to associate content with the media file or copy thereof.

22. A computer readable medium containing instructions which, when executed in a processing system, causes the processing system to perform a method of claim 6 further comprising creating a plug-in enhancement to a digital media player, the plug-in obtaining the metadata of the digital media file.

23. A computer readable medium containing instructions which, when executed in a processing system, causes the processing system to perform a method of claim 6 further comprising:
c) associating operator content with a digital media file;
d) launching content that has been associated with the digital media file.

24. A computer readable medium containing instructions which, when executed in a processing system, causes the processing system to perform a method claim 6 further comprised of:
c) retrieving content resources associated with a particular digital media file;
d) displaying the content resources associated with a particular digital media file.

25. A computer readable medium containing instructions which, when executed in a processing system, causes the processing system to perform a method of claim 9 further comprised of using the metadata obtained from the digital media file as parameters in a database query to retrieve content resources associated with the digital media.

26. A computer readable medium containing instructions which, when executed in a processing system, causes the processing system to perform a method of claim 9 further comprised of the server computer transforming the content resources, once retrieved, into a format suitable for access on the client computer and transmitting the content resources to the client computer.

27. A computer readable medium containing instructions which, when executed in a processing system, causes the processing system to perform a method of claim 12 further comprised wherein the format used to display the content resources is a WebPipe, the WebPipe being an apparatus for navigating through a set series of URL-addressed resources with additional features.

28. A computer readable medium containing instructions which, when executed in a processing system, causes the processing system to perform a method comprised of:
e) creating a list of topics
f) harvesting a plurality of content document URLs from a plurality of web sites;
g) associating the harvested URLs, based on the content of the document referred to by each URL respectively, to the appropriate topic;
h) assembling the topics and the URLs therein into a format capable of being transmitted and viewed on a client computer.

29. A computer readable medium containing instructions which, when executed in a processing system, causes the processing system to perform a method of claim 12 further comprised of having a listing of topics relevant to a specific digital media instance automatically retrieved by a client program and automatically displayed to the operator upon the operator's playing of the specific digital media file.

30. A computer readable medium containing instructions which, when executed in a processing system, causes the processing system to perform a method of claim 14 further comprised of having the results presented in a WebPipe.
